(19) United States
(12) Patent Application Publication
(10) Pub. No.: US 2019/0356866 A1
(43) Pub. Date: Nov. 21, 2019

(54) Frame Stitching And Other Functions Using Multiple Cameras

(71) Applicant: Eaton Intelligent Power Limited, Dublin 4 (IE)

(72) Inventors: Joshua Seth Olson, Peachtree City, GA (US); Dominic Pritham, Atlanta, GA (US); Ameya Ainapure, Atlanta, GA (US); Bruce Douglas, Fayetteville, GA (US)

(21) Appl. No.: 16/410,387

(22) Filed: May 13, 2019

Related U.S. Application Data
(60) Provisional application No. 62/671,856, filed on May 15, 2018.

(51) Int. Cl. H04N 5/262; H04N 13/239; G06T 7/292

(52) U.S. Cl. CPC H04N 5/2624; G06T 7/292; H04N 13/239

(57) ABSTRACT

A system disposed in a volume of space can include a first camera disposed in the volume of space, where the first camera captures a first image of a first portion of the volume of space. The system can also include a second camera disposed in the volume of space, where the second camera captures a second image of a second portion of the volume of space. The system can further include a controller communicably coupled to the first camera and the second camera. The controller can receive the first image from the first camera and the second image from the second camera. The controller can also generate a resulting image by combining the first image and the second image. The controller can further perform an action using the resulting image.

### CROSS-REFERENCE TO RELATED APPLICATIONS

This application claims priority under 35 U.S.C. § 119 to U.S. Provisional Patent Application Ser. No. 62/671,856, titled “Frame Stitching Using Multiple Electrical Devices” and filed on May 15, 2018, the entire contents of which are hereby incorporated herein by reference.

### TECHNICAL FIELD

Embodiments described herein relate generally to mapping and locating objects in a volume of space, and more particularly to systems, methods, and devices for frame stitching using a light fixture.

### BACKGROUND

Cameras are being used increasingly for different applications. For example, cameras are commonly used for security. Sometimes, cameras are used as stand-alone devices. In other cases, cameras are integrated with an electrical device, such as a doorbell or light fixture.

### SUMMARY

In general, in one aspect, the disclosure relates to a system disposed in a volume of space. The system can include a first camera disposed in the volume of space, where the first camera captures a first image of a first portion of the volume of space. The system can also include a second camera disposed in the volume of space, where the second camera captures a second image of a second portion of the volume of space. The system can further include a controller communicably coupled to the first camera and the second camera. The controller can receive the first image from the first camera and the second image from the second camera. The controller can also generate a resulting image by combining the first image and the second image. The controller can further perform an action using the resulting image.

In another aspect, the disclosure can generally relate to an electrical device disposed in a volume of space. The electrical device can include a first camera configured to capture a first image of a first portion of the volume of space. The electrical device can also include a controller coupled to the first camera. The controller can be configured to control the first camera to capture the first image. The controller can also be configured to receive the first image from the first camera. The controller can further be configured to receive at least one second image from at least one second camera, where the at least one second image is of at least one second portion of the volume of space. The controller can also be configured to generate a resulting image using the first image and the at least one second image. The controller can further be configured to perform an action using the resulting image.

In yet another aspect, the disclosure can generally relate to a controller. The controller can include a memory that stores a plurality of instructions. The controller can also include a hardware processor. The controller can further include a control engine executing the plurality of instructions on the hardware processor. The controller can be configured to receive multiple images from a plurality of cameras. The controller can also be configured to generate a resulting image using at the multiple images. The controller can further be configured to perform an action using the resulting image.

These and other aspects, objects, features, and embodiments will be apparent from the following description and the appended claims.

### BRIEF DESCRIPTION OF THE DRAWINGS

The drawings illustrate only example embodiments of frame stitching using multiple electrical devices and are therefore not to be considered limiting of its scope, as frame stitching using multiple electrical devices may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a diagram of a system that includes an electrical device in accordance with certain example embodiments.

FIG. 2 shows a computing device in accordance with certain example embodiments.

FIG. 3 shows a lighting system located in a volume of space in accordance with certain example embodiments.

FIG. 4 shows a light fixture in accordance with certain example embodiments.

FIG. 5 shows an image captured by a camera of an electrical device in accordance with certain example embodiments.

FIGS. 6A and 6B show an example system in accordance with certain example embodiments.

FIG. 7 shows a collection of discrete images captured by the system of FIGS. 6A and 6B.

FIG. 8 shows a resulting image using the images of FIG. 7 in accordance with certain example embodiments.

FIG. 9 shows a lighting system in a healthcare environment in accordance with certain example embodiments.

FIG. 10 shows a lighting system in a manufacturing environment in accordance with certain example embodiments.

### DETAILED DESCRIPTION OF EXAMPLE EMBODIMENTS

The example embodiments discussed herein are directed to systems, methods, and devices for frame stitching using multiple electrical devices. While example embodiments are described herein as using light fixtures (or components thereof) to facilitate frame stitching, example embodiments can use one or more of a number of other electrical devices in addition to, or as an alternative to, light fixtures. Such other electrical devices can include, but are not limited to, a light switch, a control panel, a wall outlet, a smoke detector, a CO₂ monitor, a motion detector, a broken glass sensor, and a camera.

Example embodiments can be used to locate one or more objects in a volume of space in real time. When the location is done in real-time, the system to implement this process is often referred to as a real-time location system (RLTS). As used herein, “real time” refers to a user's perspective of the system and means that objects can be located within the time in which the signals are transmitted and processed, such as a few milliseconds to within a few seconds, which time is virtually real time from the user's perspective.

Example embodiments can be used for a volume of space having any size and/or located in any environment (e.g., indoor, outdoor, hazardous, non-hazardous, high humidity, low temperature, corrosive, sterile, high vibration). Further, example embodiments can be used with any of a number of other types of signals, including but not limited to radio frequency (RF) signals, WiFi, Bluetooth, Bluetooth Low Energy (BLE), visible light communication (VLC), RFID, ultraviolet waves, microwaves, and infrared signals. Example embodiments can be used to locate an object in a volume of space in real time.

Light fixtures described herein can use one or more of a number of different types of light sources, including but not limited to light-emitting diode (LED) light sources, fluorescent light sources, organic LED light sources, incandescent light sources, and halogen light sources. Therefore, light fixtures described herein, even in hazardous locations, should not be considered limited to a particular type of light source. A light fixture described herein can be any of a number of different types of light fixtures, including but not limited to a pendant light fixture, a troffer light fixture, a floodlight, a spot light, a highbay light fixture, and a recessed light fixture.

A user may be any person that interacts with a light fixture and/or other object in a volume of space. Specifically, a user may program, operate, and/or interface with one or more components (e.g., a controller, a network manager) associated with a system using example embodiments. Examples of a user may include, but are not limited to, an engineer, an electrician, an instrumentation and controls technician, a mechanic, an operator, a consultant, a contractor, an asset, a network manager, and a manufacturer's representative.

As defined herein, an object can be any unit or group of units. An object can move on its own, is capable of being moved, or is stationary. Examples of an object can include, but are not limited to, a person (e.g., a user, a visitor, an employee), a part (e.g., a motor stator, a cover), a piece of equipment (e.g., a fan, a container, a table, a chair, a computer, a printer), an assembly line, a work bench, shelving, a portion of a structure (e.g., a wall, a door, a window), or a group of parts of equipment (e.g., a pallet stacked with inventory).

As used herein, the term “frame stitching” (also called “stitching”) refers to the process of taking images of portions of a volume of space, captured by multiple image capture devices (also called cameras herein), and piecing those images together to create a single overall image of the volume of space. Piecing together the various images can involve adjacent images that overlap each other and/or adjacent images that do not overlap each other. Also, piecing together the various images can involve manipulating (e.g., cropping, zooming out, zooming in) one or more of those images to create the single overall image of the volume of space. The images that are used in frame stitching can be still images, segments of video, or some combination thereof.

In certain example embodiments, electrical devices used for frame stitching are subject to meeting certain standards and/or requirements. For example, the National Electric Code (NEC), the National Electrical Manufacturers Association (NEMA), the International Electrotechnical Commission (IEC), Underwriters Laboratories (UL), the Federal Communication Commission (FCC), the Bluetooth Special Interest Group, and the Institute of Electrical and Electronics Engineers (IEEE) set standards that can be applied to electrical enclosures (e.g., light fixtures), wiring, location services, and electrical connections. Use of example embodiments described herein meet (and/or allow a corresponding device to meet) such standards when required. In some (e.g., PV solar) applications, additional standards particular to that application may be met by the electrical devices described herein.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of frame stitching using electrical devices will be described more fully hereinafter with reference to the accompanying drawings, in which example embodiments of frame stitching using electrical devices are shown. Frame stitching using electrical devices may, however, be embodied in many different forms and should not be construed as limited to the example embodiments set forth herein. Rather, these example embodiments are provided so that this disclosure will be thorough and complete, and will fully convey the scope of frame stitching using electrical devices to those of ordinary skill in the art. Like, but not necessarily the same, elements (also sometimes called components) in the various figures are denoted by like reference numerals for consistency.

Terms such as “first”, “second”, “third”, “subsequent”, “outer”, “inner”, “top”, “bottom”, “on”, and “within” are used merely to distinguish one component (or part of a component or state of a component) from another. Such terms are not meant to denote a preference or a particular orientation, and such terms are not meant to limit embodiments of frame stitching using electrical devices. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

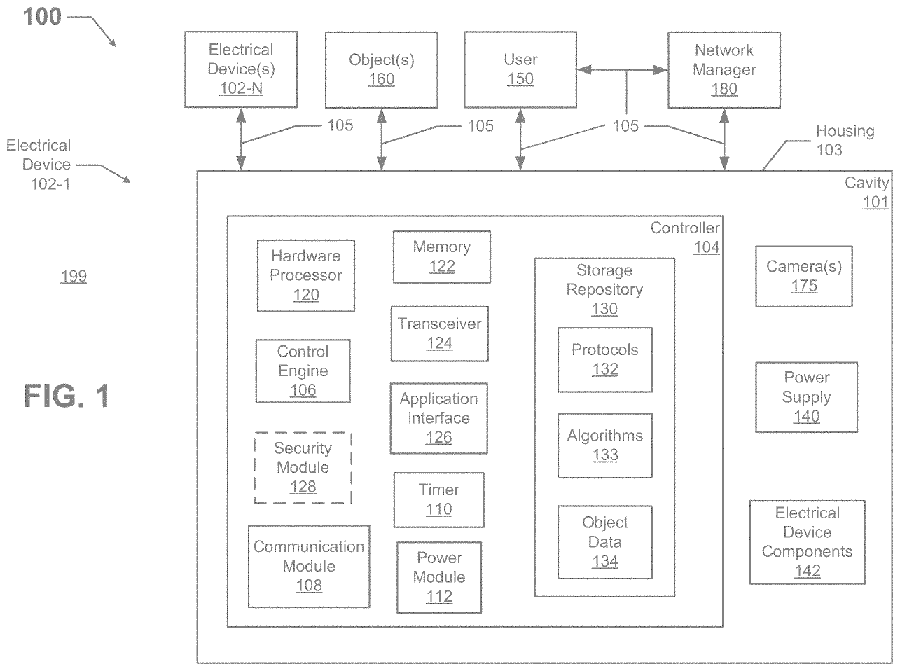

FIG. 1 shows a diagram of a system 100 that includes multiple electrical devices 102 (e.g., electrical device 102-1, electrical devices 102-N) in accordance with certain example embodiments. The system 100 can include one or more objects 160, a user 150, and a network manager 180, some or all of which can be located in a volume of space 199. The electrical device 102-1 can include a controller 104, one or more cameras 175, a power supply 140, and a number of electrical device components 142. The controller 104 of the electrical device 102-1 can include one or more of a number of components. Such components, can include, but are not limited to, a control engine 106, a communication module 108, a timer 110, a power module 112, a storage repository 130, a hardware processor 120, a memory 122, a transceiver 124, an application interface 126, and, optionally, a security module 128.

An electrical device 102 can be any type of device that uses electricity to operate. Examples of an electrical device 102 are listed above. One or more of the components of the electrical device 102-1 can also be included in one or more of the other electrical devices 102-N in the system 100. Alternatively, a component (e.g., the controller 104) shown in FIG. 1 can be a stand-alone component.

The components shown in FIG. 1 are not exhaustive, and in some embodiments, one or more of the components shown in FIG. 1 may not be included in the example system 100. For instance, any component of the example electrical device 102-1 can be discrete or combined with one or more other components of the electrical device 102-1. As an example, the controller 104 can be part of the camera 175.

The user 150 is the same as a user defined above. The user 150 can use a user system (not shown), which may include a display (e.g., a GUI). The user 150 interacts with (e.g., sends data to, receives data from) the controller 104 of an electrical device 102-1 via the application interface 126 (described below). The user 150 can also interact with a network manager 180 and/or one or more of the objects 160. Interaction between the user 150, the electrical devices 102, and the network manager 180 is conducted using communication links 105. In some cases, the user 150, the electrical devices 102, and/or the network manager 180 can also interact with the object 160 using communication links 105.

Each communication link 105 can include wired (e.g., Class 1 electrical cables, Class 2 electrical cables, electrical connectors) and/or wireless (e.g., Wi-Fi, visible light communication, cellular networking, Bluetooth, Bluetooth Low Energy (BLE), WirelessHART, ISA100, Power Line Carrier, RS485, DALI) technology. For example, a communication link 105 can be (or include) one or more electrical conductors that are coupled to the housing 103 of an electrical device 102-1 and to the network manager 180. The communication link 105 can transmit signals (e.g., power signals, communication signals, control signals, data) between the electrical devices 102, the user 150, and the network manager 180. In some cases, if an object 160 has a type of communication module, one or more objects 160 can communicate with the user 150, one or more electrical devices 102, and/or the network manager 180 using the communication links 105.

The network manager 180 is a device or component that controls all or a portion of the system 100 that includes the controller 104 of the electrical device 102-1 and the controllers of the other electrical devices 102-N. The network manager 180 can be or include components that are substantially similar to the controller 104. Alternatively, the network manager 180 can include one or more of a number of features in addition to, or altered from, the features of the controller 104 described below.

The one or more objects 160 can be any unit or group of units located in the volume of space 199. An object 160 can move on its own, is capable of being moved, or is stationary. Examples of an object 160 can include, but are not limited to, a person (e.g., a user, a visitor, an employee), a part (e.g., a motor stator, a cover), a piece of equipment (e.g., a fan, a container, a table, a chair, a computer, a printer), or a group of parts of equipment (e.g., a pallet stacked with inventory). In some cases, an object 160 can include a type of communication device, which can include one or more components (e.g., antenna, transceiver), such as components included in the electrical device 102-1, that allow the object 160 to communicate.

The user 150, the network manager 180, the object 160, and/or any other applicable electrical devices 102-N can interact with the controller 104 of the electrical device 102-1 using the application interface 126 in accordance with one or more example embodiments. Specifically, the application interface 126 of the controller 104 receives data (e.g., information, communications, instructions) from and sends data (e.g., information, communications, instructions) to the user 150, the controller 104 of another electrical device 102-N, an object 160, and/or the network manager 180. The user 150, an object 160, and the network manager 180 can include an interface to receive data from and send data to the controller 104 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

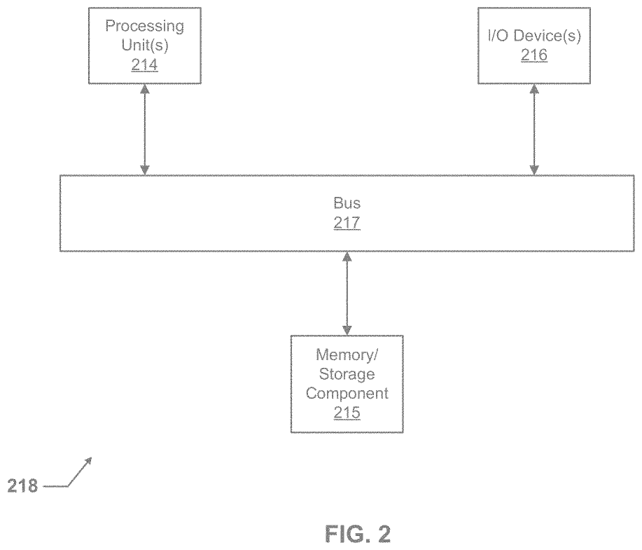

The controller 104, the user 150, an object 160, and the network manager 180 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 104. Examples of such a system can include, but are not limited to, a desktop computer with Local Area Network (LAN), Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 2.

Further, as discussed above, such a system can have corresponding software (e.g., user software, controller software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

The electrical device 102-1 can include a housing 103. The housing 103 can include at least one wall that forms a cavity 101. In some cases, the housing 103 can be designed to comply with any applicable standards so that the electrical device 102-1 can be located in a particular environment (e.g., a hazardous environment). For example, if the electrical device 102-1 is located in an explosive environment, the housing 103 can be explosion-proof. According to applicable industry standards, an explosion-proof enclosure is an enclosure that is configured to contain an explosion that originates inside, or can propagate through, the enclosure.

The housing 103 of the electrical device 102-1 can be used to house one or more components of the electrical device 102-1, including one or more components of the controller 104. For example, as shown in FIG. 1, the controller 104 (which in this case includes the control engine 106, the communication module 108, the timer 110, the power module 112, the storage repository 130, the hardware processor 120, the memory 122, the transceiver 124, the application interface 126, and the optional security module 128), the power supply 140, the one or more cameras 175, and the electrical device components 142 are disposed in the cavity 101 formed by the housing 103. In alternative embodiments, any one or more of these or other components of the electrical device 102-1 can be disposed on the housing 103 and/or remotely from the housing 103.

The storage repository 130 can be a persistent storage device (or set of devices) that stores software and data used to assist the controller 104 in communicating with the user 150, the network manager 180, one or more of the objects 160, and any other applicable electrical devices 102-N within the system 100. In one or more example embodiments, the storage repository 130 stores one or more protocols 132, one or more algorithms 133, and stored data 134. The protocols 132 can be any procedures (e.g., a series of method steps) and/or other similar operational procedures that the control engine 106 of the controller 104 follows based on certain conditions at a point in time.

The protocols 132 can also include any of a number of communication protocols that are used to send and/or receive data between the controller 104 and the user 150, the network manager 180, any other applicable electrical devices 102-N, and one or more of the objects 160. One or more of the communication protocols 132 can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the communication protocols 132 can provide a layer of security to the data transferred within the system 100.

The algorithms 133 can be any formulas, mathematical models, forecasts, simulations, and/or other similar tools that the control engine 106 of the controller 104 uses to reach a computational conclusion. An example of one or more algorithms 133 is combining two images captured by two adjacent cameras 175 into a single resulting image. These algorithms 133 can be used, for example, to determine distances (e.g., absolute, relative), in two or three dimensions, of objects 160 and/or electrical devices 102 in the volume of space 199, to combine an overlapping portion of multiple images, and to identify objects 160 and/or electrical devices 102 captured in an image. Algorithms 133 can be used to analyze past data, analyze current data, and/or perform forecasts.

Stored data 134 can be any historical, present, and/or forecast data. Stored data 134 can be associated with an object 160, any of the electrical devices 102, the network manager 180, a user 150, and a camera 175. Such data can include, but is not limited to, a manufacturer of the object 160, a model number of the object 160, a location of another light fixture 102, images captured by a camera 175, settings, default values, user preferences, communication capability of an object 160, last known location of the object 160, and age of the object 160.

The storage repository 130 can also include other types of data, including but not limited to historical measurements, results of the algorithms 133, user preferences, threshold values, and software updates. For example, the storage repository 130, through a combination of protocols 132 and/or algorithms 133, can allow the control engine 106 of the controller 104 to commission one or more of the electrical devices 102 in the volume of space 199. As another example, the storage repository 130, through a combination of protocols 132 and/or algorithms 133, can allow the control engine 106 of the controller 104 to “stitch” together multiple images captured by multiple cameras 175, where each image if of a portion of the volume of space 199, to generate a single comprehensive image of the volume of space 199. As yet another example, the storage repository 130, through a combination of protocols 132 and/or algorithms 133, can allow the control engine 106 of the controller 104 to fill in a gap or “dead spot” in the resulting single comprehensive image of the volume of space 199, where the gap results from a lack of overlap between adjacent images of a portion of the volume of space 199.

Examples of a storage repository 130 can include, but are not limited to, a database (or a number of databases), a file system, a hard drive, flash memory, some other form of solid state data storage, or any suitable combination thereof. The storage repository 130 can be located on multiple physical machines, each storing all or a portion of the protocols 132, algorithms 133, and/or the stored data 134 according to some example embodiments. Each storage unit or device can be physically located in the same or in a different geographic location.

The storage repository 130 can be operatively connected to the control engine 106. In one or more example embodiments, the control engine 106 includes functionality to communicate with the user 150, the network manager 180, any other applicable electrical devices 102-N, and the objects 160 in the system 100. More specifically, the control engine 106 sends information to and/or receives information from the storage repository 130 in order to communicate with the user 150, the network manager 180, any other applicable electrical devices 102-N, and/or the objects 160. As discussed below, the storage repository 130 can also be operatively connected to the communication module 108 in certain example embodiments.

In certain example embodiments, the control engine 106 of the controller 104 controls the operation of one or more other components (e.g., the communication module 108, the timer 110, the transceiver 124) of the controller 104. For example, the control engine 106 can put the communication module 108 in “sleep” mode when there are no communications between the controller 104 and another component (e.g., an object 160, the user 150) in the system 100 or when communications between the controller 104 and another component in the system 100 follow a regular pattern. In such a case, power consumed by the controller 104 is conserved by only enabling the communication module 108 when the communication module 108 is needed.

As another example, the control engine 106 can direct the timer 110 when to provide a current time, to begin tracking a time period, and/or perform another function within the capability of the timer 110. As yet another example, the control engine 106 can operate (e.g., turn on, turn off, pan, zoom, capture video, capture a still image) one or more of the cameras 175. This example provides another instance where the control engine 106 can conserve power used by the controller 104 and other components (e.g., a camera) of the electrical device 102-1.

The control engine 106 of the controller 104 can, in some cases, receive images taken by one or more cameras 175 from one or more other electrical devices 102 and stitch the images together to create a single comprehensive image. The control engine 106 of the controller 104 can also determine the location of an object 160 in the volume of space 199 based on the single generated from stitching multiple images of portions of the volume of space 199 together. In some cases, each electrical device 102 can have some form of a controller 104. The control engine 106 of one controller 104 of the electrical device 102-1 can coordinate with the controllers 104 of one or more of the other electrical devices 102-N.

With or without stitching, and with or without the coordination of multiple cameras 175, the control engine 106 can analyze the contents of an image captured by a camera 175 and, using one or more algorithms 133 and/or protocols 132, identify one or more objects 160 in the portion of the volume of space 199 captured by the image and/or map (e.g., determine two-dimensional or three-dimensional positions) of one or more objects 160 in the portion of the volume of space 199 captured by the camera 175. These functions can be performed in real time so that the system 100 is, or is part of, a RTLS system.

In certain example embodiments, the control engine 106 of the controller 104 can compare a current image of a portion of the volume of space 199 captured by a camera 175 and compare it with a previous image of the portion of the volume of space 199 captured by the camera 175. If there are no differences between the images, or if there are at least no differences in a relevant aspect of the images, then the control engine 106 can simply send a message reporting no change to the image captured by the camera 175 rather than sending the image itself, which requires significantly more bandwidth on the communication links 105. For example, if an object 160 captured by the images has not moved, and the location of the object 160 is something that an example system 100 is tracking, then the control engine 106 can simply send a message that the previous image captured by the camera 175 can continued to be used for tracking the object 160 in the volume of space 199. If the control engine 106 is tracking the object 160, then the control engine 106 can discard the subsequent image to save storage space in the storage repository 130 and processing time.

In some cases, if a camera 175 has alterable control aspects (e.g., pan, tilt, zoom, shutter speed), the control engine 106 of the controller 104, using a combination of protocols 132 and/or algorithms 133, can control these control aspects of the camera 175. For example, if a camera 175 captures an image, and the control engine 106 is unable to interpret some of all of the image in performing a particular function (e.g., commissioning, identifying an object 160, tracking an object 160, mapping), then the control engine 106 can instruct the camera 175 to change one or more of its control aspects, capture another image using those altered control aspects, and send the new image to the control engine 106. This new image may enable the control engine 106 to clarify the aspect of the original image that could not be clearly interpreted.

For example, the control engine 106 of the controller 104, using a combination of protocols 132 and/or algorithms 133, can commission one or more of the electrical devices 102 in the volume of space 199. As another example, the control engine 106 of the controller 104, using a combination of protocols 132 and/or algorithms 133, can stitch together multiple images captured by multiple cameras 175, where each image if of a portion of the volume of space 199, to generate a single comprehensive image of the volume of space 199. As yet another example, the control engine 106 of the controller 104, through a combination of protocols 132 and/or algorithms 133, can fill in a gap or “dead spot” in the resulting single comprehensive image of the volume of space 199, where the gap results from a lack of overlap between adjacent images of a portion of the volume of space 199.

In some cases, the control engine 106 of the controller 104 can use one or more protocols 132 and/or algorithms 133 to determine, using stitching techniques embedded in the protocols 132 and/or algorithms 133, the location of the object 160 in the volume of space 199 in two dimensions (e.g., along a horizontal plane). In other cases, the control engine 106 can also use one or more protocols 132 and/or algorithms 133 to determine the three-dimensional location of the object 160 in the volume of space 199.

The control engine 106 can provide control, communication, and/or other signals to the user 150, the network manager 180, the other electrical devices 102-N, and/or one or more of the objects 160. Similarly, the control engine 106 can receive control, communication, and/or other signals from the user 150, the network manager 180, the other electrical devices 102-N, and/or one or more of the objects 160. The control engine 106 can communicate automatically (for example, based on one or more protocols 132 and/or algorithms 133 stored in the storage repository 130) and/or based on control, communication, and/or other similar signals received from another device (e.g., the network manager 180). The control engine 106 may include a printed circuit board, upon which the hardware processor 120 and/or one or more discrete components of the controller 104 can be positioned.

In certain example embodiments, the control engine 106 can include an interface that enables the control engine 106 to communicate with one or more components (e.g., power supply 140) of the electrical device 102-1. For example, if the power supply 140 of the electrical device 102-1 (in this example, a light fixture) operates under IEC Standard 62386, then the power supply 140 can include a digital addressable lighting interface (DALI). In such a case, the control engine 106 can also include a DALI to enable communication with the power supply 140 within the electrical device 102-1. Such an interface can operate in conjunction with, or independently of, the communication protocols 132 used to communicate between the controller 104 and the user 150, the network manager 180, any other applicable electrical devices 102-N, and the objects 160.

The control engine 106 (or other components of the controller 104) can also include one or more hardware and/or software architecture components to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

Using example embodiments, while at least a portion (e.g., the control engine 106, the timer 110) of the controller 104 is always on, the remainder of the controller 104 can be in sleep mode when they are not being used. In addition, the controller 104 can control certain aspects (e.g., sending images to and receiving images from another electrical device 102 and/or the network manager 180) of one or more other applicable components in the system 100.

The communication network (using the communication links 105) of the system 100 can have any type of network architecture. For example, the communication network of the system 100 can be a mesh network. As another example, the communication network of the system 100 can be a star network. When the controller 104 includes an energy storage device (e.g., a battery as part of the power module 112), even more power can be conserved in the operation of the system 100. In addition, using time-synchronized communication protocols 132, the data transferred between the controller 104 and the user 150, the network manager 180, an object, and/or any other applicable electrical devices 102-N can be secure.

The communication module 108 of the controller 104 determines and implements the communication protocol (e.g., from the protocols 132 of the storage repository 130) that is used when the control engine 106 communicates with (e.g., sends signals to, receives signals from) the user 150, the network manager 180, any other applicable electrical devices 102-N, and/or one or more of the objects 160. In some cases, the communication module 108 accesses the stored data 134 to determine which communication protocol is within the capability of a target component of the system 100. In addition, the communication module 108 can interpret the communication protocol of a communication received by the controller 104 so that the control engine 106 can interpret the communication.

The communication module 108 can send data (e.g., protocols 132, stored data 134) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can measure multiple times simultaneously. The timer 110 can track time periods based on an instruction received from the control engine 106, based on an instruction received from the user 150, based on an instruction programmed in the software for the controller 104, based on some other condition or from some other component, or from any combination thereof.

The power module 112 of the controller 104 provides power to one or more other components (e.g., timer 110, control engine 106) of the controller 104. In addition, in certain example embodiments, the power module 112 can provide power to the power supply 140 of the electrical device 102-1. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned.

The power module 112 can include one or more components (e.g., a transformer, a diode bridge, an inverter, a converter) that receives power (for example, through an electrical cable) from the power supply 140 and/or from a source external to the electrical device 102-1, and then generates power of a type (e.g., alternating current, direct current) and level (e.g., 12V, 24V, 120V) that can be used by the other components of the controller 104 and/or by the power supply 140. In addition, or in the alternative, the power module 112 can be a source of power in itself to provide signals to the other components of the controller 104 and/or the power supply 140. For example, the power module 112 can be a battery. As another example, the power module 112 can be a localized photovoltaic power system.

The hardware processor 120 of the controller 104 executes software in accordance with one or more example embodiments. Specifically, the hardware processor 120 can execute software on the control engine 106 or any other portion of the controller 104, as well as software used by the user 150, and the network manager 180, and/or any other applicable electrical devices 102-N. The hardware processor 120 can be an integrated circuit, a central processing unit, a multi-core processing chip, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more insulated-gate bipolar transistors (IGBTs), and/or one or more integrated circuits (ICs). Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 104 can send and/or receive data, control, and/or communication signals. Specifically, the transceiver 124 can be used to transfer data between the controller 104 and the user 150, the network manager 180, any other applicable electrical devices 102-N, and/or the objects 160. The transceiver 124 can use wired and/or wireless technology. The transceiver 124 can be configured in such a way that the data, control, and/or communication signals sent and/or received by the transceiver 124 can be received and/or sent by another transceiver that is part of the user 150, the network manager 180, any other applicable electrical devices 102-N, and/or the objects 160.

When the transceiver 124 uses wireless technology, any type of wireless technology can be used by the transceiver 124 in sending and receiving signals. Such wireless technology can include, but is not limited to, Wi-Fi, visible light communication, cellular networking, Bluetooth, and BLE. The transceiver 124 can use one or more of any number of suitable communication protocols (e.g., ISA100, HART) when sending and/or receiving signals. Such communication protocols can be stored in the protocols 132 of the storage repository 130. Further, any transceiver information for the user 150, the network manager 180, any other applicable electrical devices 102-N, and/or the objects 160 can be part of the stored data 134 (or similar areas) of the storage repository 130.

Optionally, in one or more example embodiments, the security module 128 secures interactions between the controller 104, the user 150, the network manager 180, any other applicable electrical devices 102-N, and/or the objects 160. More specifically, the security module 128 authenticates communication from software based on security keys verifying the identity of the source of the communication. For example, user software may be associated with a security key enabling the software of the user 150 to interact with the controller 104 of the electrical device 102-N. Further, the security module 128 can restrict receipt of information, requests for information, and/or access to information in some example embodiments.

As mentioned above, aside from the controller 104 and its components, the electrical device 102-1 can include a power supply 140, one or more cameras 175, and one or more electrical device components 142. The electrical device components 142 of the electrical device 102-1 are devices and/or components typically found in an electrical device to allow the electrical device 102-1 to operate. An electrical device component 142 can be electrical, electronic, mechanical, or any combination thereof. The electrical device 102-1 can have one or more of any number and/or type of electrical device components 142. If the electrical device 102 is a light fixture, examples of such electrical device components 142 can include, but are not limited to, a light source, a light engine, a heat sink, an electrical conductor or electrical cable, a terminal block, a lens, a diffuser, a reflector, an air moving device, a baffle, a dimmer, and a circuit board.

The power supply 140 of the electrical device 102-1 can provide power to the controller 104, the camera 175, and/or one or more of the electrical device components 142. The power supply 140 can be substantially the same as, or different than, the power module 112 of the controller 104. The power supply 140 can include one or more of a number of single or multiple discrete components (e.g., transistor, diode, resistor), and/or a microprocessor. The power supply 140 may include a printed circuit board, upon which the microprocessor and/or one or more discrete components are positioned.

The power supply 140 can include one or more components (e.g., a transformer, a diode bridge, an inverter, a converter) that receives power (for example, through an electrical cable) from or sends power to the power module 112 of the controller 104. The power supply can generate, based on power that it receives, power of a type (e.g., alternating current, direct current) and level (e.g., 12V, 24V, 120V) that can be used by the recipients (e.g., the electrical device components 142, the controller 106) of such power. In addition, or in the alternative, the power supply 140 can receive power from a source external to the electrical device 102-1 or from the power module 112 of the controller 104. In addition, or in the alternative, the power supply 140 can be a source of power in itself. For example, the power supply 140 can be a battery, a localized photovoltaic power system, or some other source of independent power.

As discussed above, the electrical device 102-1 includes one or more cameras 175. A camera 175 (also more generally referred to as an image capture device) is a device that captures still or moving images of a portion of a volume of space 199. A camera 175 can capture images in color or black-and-white. A camera 175 can capture images in digital or analog. A camera 175 can have one or more of any number of components, including but not limited to a lens, a shutter, a flash, storage, a hardware processor, memory, a power module, and a controller. Some of these components of a camera 175 can be duplicative of, or shared with, the controller 104 or other associated components of the electrical device 102.

A camera 175 can be in a fixed position and capture a constant portion of a volume of space 199. Alternatively, a camera 175 can have some capabilities or settings (e.g., pan, tilt, zoom, panoramic) that allow for some control over the portion of the volume of space 199 that the camera 175 can capture an image or series of images. Such control can be directed by one or more components of the system 100, including but not limited to the controller 104 of the electrical device 102-1, a controller of another electrical device 102-N, the network manager 180, another camera 175, and a user 150.

As stated above, a camera 175 can be communicably coupled to the controller 104 of the electrical device 102. In such a case, the controller 104 can control the operation and/or the settings (e.g., pan, tilt, zoom, panoramic, shutter speed, digital quality) of the camera 175 and when the camera 175 captures an image for a particular portion of a volume of space 199. Similarly, the controller 104 can receive each image captured by the camera 175 so that the image can be processed with other images from other cameras in the system 100 so that the controller 104, another controller in the system 100, or the network manager 180 can stitch together all of the images to generate a single comprehensive image of the volume of space 199.

In alternative embodiments, the operation and/or settings of a camera 175 can be controlled by another component (e.g., a controller of the camera 175, a controller of another electrical device 102-N, the network manager 180) aside from the controller 104 of the electrical device 102-1. In certain example embodiments, a camera 175 can be disposed at, within, or on any portion of the electrical device 102-1. For example, a camera 175 can be disposed on the housing 103 of the electrical device 102-1. As another example, a camera 175 can be disposed within the cavity 101 of the housing 103, where the lens peeks through an aperture that traverses the housing 103 of the electrical device 102-1.

In yet other alternative embodiments, a camera 175 can be a stand-alone component that is physically separated from the housing 103 of the electrical device 102-1. In such a case, the camera 175 can be communicably coupled to the controller 104 of the electrical device 102-1 using one or more communication links 105. Also, in such a case, the camera 175 can be considered an electrical device 102. Alternatively, the camera 175 can have its own controller 104, including one or more components (e.g., hardware processor 120, transceiver 124, storage repository 130) thereof. In such a case, the camera 175 can communicate with other electrical devices 102-N, other cameras 175, and/or the network manager 180 to implement one or more of the functions (e.g., mapping, commissioning, identifying an object 160, tracking an object 160) described herein.

In some cases, the information obtained by the controller 104 from the images captured by a camera 175 is dedicated to the functions (e.g., commissioning, tracking an object 160, mapping) performed by example embodiments and is independent of the operation of the electrical device 102-1. Alternatively, the information obtained by the controller 104 from the images captured by a camera 175 can also be used in the operation of one or more electrical device components 142 of the electrical device 102-1. For example, if the electrical device 102-1 is a light fixture, then a camera 175 can additionally act as a passive infrared sensor or other type of sensor that detects occupancy within a portion of the volume of space 199.

FIG. 2 illustrates one embodiment of a computing device 218 that implements one or more of the various techniques described herein, and which is representative, in whole or in part, of the elements described herein pursuant to certain exemplary embodiments. For example, the controller 104 of FIG. 1, including its various components (e.g., control engine 106, transceiver 124, hardware processor 120, memory 122) can be considered a type of computing device 218. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless buses.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a local area network (LAN), a wide area network (WAN) such as the Internet, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain exemplary embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

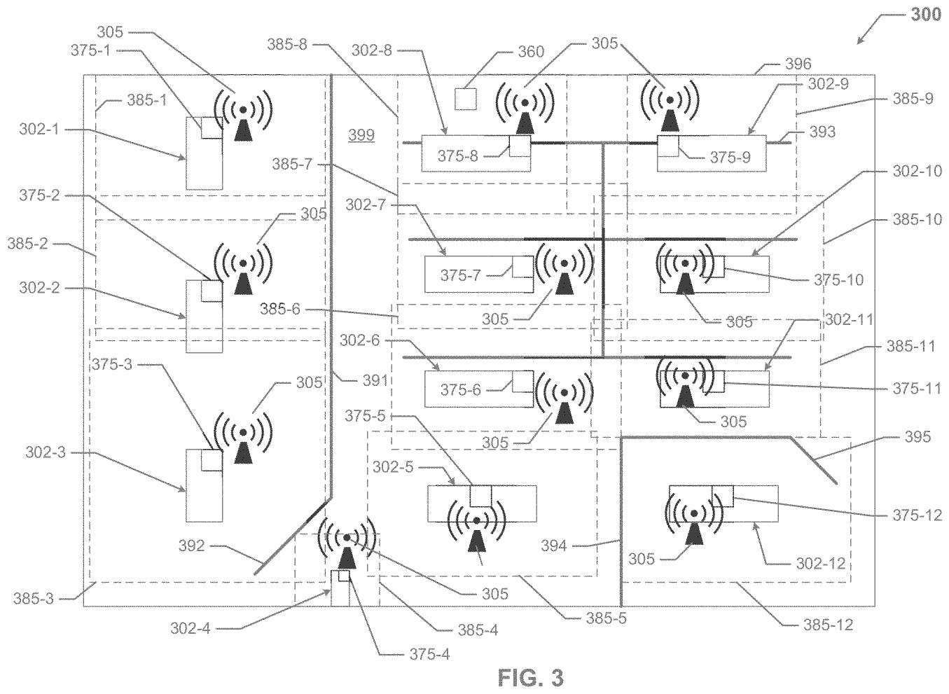

FIG. 3 shows a lighting system 300 located in a volume of space 390 in accordance with certain example embodiments. Specifically, FIG. 3 shows a system 300 in which the various light fixtures 302 are auto-commissioned. Referring to FIGS. 1 through 3, the lighting system 300 of FIG. 3 includes twelve light fixtures 302, where each light fixture 302 of FIG. 3 is substantially similar to the light fixture 102-1 of FIG. 1 described above. Specifically, the lighting system 300 includes light fixture 302-1, light fixture 302-2, light fixture 302-3, light fixture 302-4, light fixture 302-5, light fixture 302-6, light fixture 302-7, light fixture 302-8, light fixture 302-9, light fixture 302-10, light fixture 302-11, and light fixture 302-12. In this case, light fixture 302-4 is an exit light, and the other 11 light fixtures 302 are troffer lights.

Each light fixture 302 in the light system 300 of FIG. 3 includes a camera 375. Specifically, in this example, light fixture 302-1 includes camera 375-1, light fixture 302-2 includes camera 375-2, light fixture 302-3 includes camera 375-3, light fixture 302-4 includes camera 375-4, light fixture 302-5 includes camera 375-5, light fixture 302-6 includes camera 375-6, light fixture 302-7 includes camera 375-7, light fixture 302-8 includes camera 375-8, light fixture 302-9 includes camera 375-9, light fixture 302-10 includes camera 375-10, light fixture 302-11 includes camera 375-11, and light fixture 302-12 includes camera 375-12.

Each light fixture 302 of the system 300 in FIG. 3 includes a transceiver (e.g., transceiver 124), and each transceiver in this example transmits and receives radio frequency waves. These radio frequency waves provide the communication links 305 by which the light fixtures 302 (and, more specifically, the cameras 375) communicate with each other. While the transmission range of each transceiver is not shown in FIG. 3, the transmission range of the transceiver of one light fixture 302 overlaps the transmission range of the transceiver of at least one other light fixture 302 in the system 300. In this way, the communication links 305 allow all light fixtures 302 in the system 300 to be communicably coupled with each other, either directly or indirectly.

In addition, as shown in FIG. 3, the location of the camera 375 on a light fixture 302 can vary. Each camera 375 has a viewing range 385 that defines a maximum area or volume of space 390 in which the camera 375 can capture one or more images. The viewing range 385 of a camera 375 can vary in terms of distance (e.g., 10 meters, 20 feet) and/or in terms of shape (e.g., square, circular, oval). In this case, the shape of the viewing range 385 of each camera 375 is rectangular, but the distance of the viewing range 385 of each camera 375 varies.

In this case, camera 375-1 has viewing range 385-1, camera 375-2 has viewing range 385-2, camera 375-3 has viewing range 385-3, camera 375-4 has viewing range 385-4, camera 375-5 has viewing range 385-5, camera 375-6 has viewing range 385-6, camera 375-7 has viewing range 385-7, camera 375-8 has viewing range 385-8, camera 375-9 has viewing range 385-9, camera 375-10 has viewing range 385-10, camera 375-11 has viewing range 385-11, and camera 375-12 has viewing range 385-12.

In some cases, the viewing range 385 of one camera 375 intersects with the viewing range 385 of another camera 375. In this example, viewing range 385-1 intersects viewing range 385-2, which intersects viewing range 385-3, which intersects viewing range 385-4, which intersects viewing range 385-5, which intersects viewing range 385-6, which intersects viewing range 385-7, which intersects viewing range 385-8, which intersects viewing range 385-9, which intersects viewing range 385-10, which intersects viewing range 385-11. Camera 375-12 is located in its own room, bounded by walls 394 and door 395, and so viewing range 385-12 does not intersect with any of the other viewing ranges 385 of the other cameras 375 in the system 300. In other words, each viewing range 385 (with the exception of viewing range 385-12) of the cameras 375 of the light fixtures 302 of FIG. 3 overlaps with at least one other viewing range 385.

The light fixtures 302 of the lighting system 300 of FIG. 3 are located within a volume of space 399. As discussed above, a volume of space 399 can be any interior and/or exterior space in which one or more light fixtures of a lighting system can be located. In this case, the volume of space 399 is part of an office space that is defined by exterior walls 396 that form the outer perimeter of the volume of space 399. The volume of space 399 in this case is divided into a number of areas. For example, a wall 391 and a door 392 separate a hallway (in which light fixture 302-1, light fixture 302-2, and light fixture 302-3 are located) from a work space (in which the remainder of the light fixtures 302 are located). Light fixture 302-4, the exit sign, is located above the door 392 within the work space.

As another example, as discussed above, wall 394 and door 395 define an office (in which light fixture 302-12 is located) within the work space. Light fixture 302-4, light fixture 302-5, light fixture 302-6, light fixture 302-7, light fixture 302-8, light fixture 302-9, light fixture 302-10, and light fixture 302-11 are located within the work space outside of the office. In addition, a number of cubicle walls 393 are located within the work space outside of the office. The communication links 305, as in this case using the radio frequency waves, can be capable of having a range that extend beyond a wall or other boundary within the volume of space 399.

In certain example embodiments, the cameras 375 of FIG. 3 can perform one or more of a number of functions by stitching together the images captured by the various cameras 375. For example, example embodiments can be used to commission the light fixtures 302 of the system 300. In such a case, the cameras 375 can capture an image within their viewing ranges 385, the images can be sent to one of the controllers (e.g., controller 104) or the master controller (e.g., master controller 180), and the images can be stitched together, resulting in the identification and precise location of each object (e.g., a light fixture 302) for commissioning. The commissioning can be performed for a new system of electrical devices, or for the replacement/addition of one or more electrical devices to an existing system.

As another example, example embodiments can be used to locate an object 359 in the volume of space 399. In such a case, the cameras 375 can capture an image within their viewing ranges 385, the images can be sent to one of the controllers (e.g., controller 104) or the master controller (e.g., master controller 180), and the images can be stitched together, resulting in the identification and precise location of the object 360 in the volume of space 399.

In some cases, the viewing range 385 of a camera 375 may not provide full coverage in the volume of space 399. For example, in this case, viewing range 385-5 of camera 375-5 has gaps with the outer wall 396, interior wall 391, and interior wall 394. In such a case, the local controller (e.g., controller 104) or the master controller (e.g., master controller 180) can pan, zoom out, and/or enable some other control of the camera 375-1, thereby eliminating such gaps in coverage.

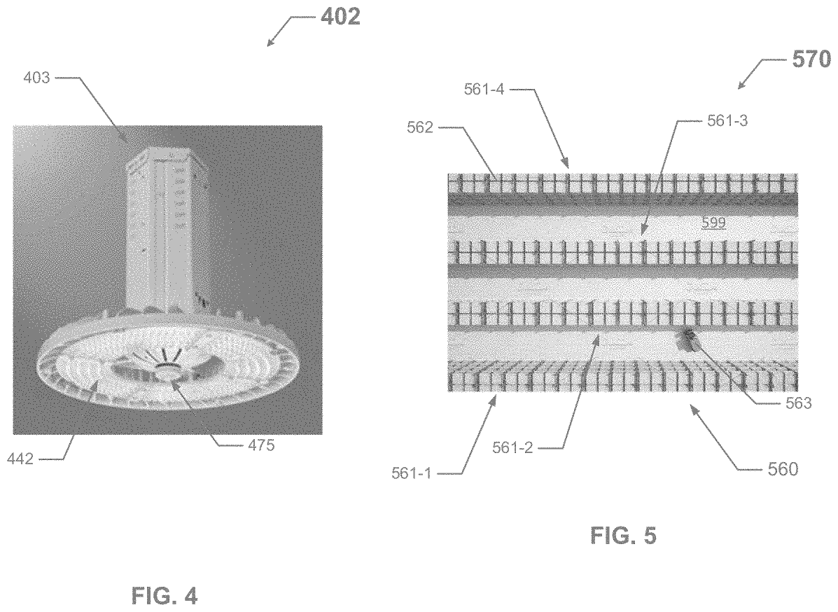

FIG. 4 shows a light fixture 402 in accordance with certain example embodiments. Referring to FIGS. 1 through 4, the light fixture 402 of FIG. 4 includes a housing 403 and a number of electrical device components 442 (in this case, light sources) disposed at the bottom of the light fixture 402. Also disposed at the bottom of the light fixture 402 is a camera 475, positioned in the substantial center of the array of light sources.

FIG. 5 shows an image 570 captured by a camera of an electrical device in accordance with certain example embodiments. Referring to FIGS. 1 through 5, the image 570 of FIG. 5 is rectangular in shape and shows a number of objects 560 in a portion of a volume of space 599. Specifically, the objects 560 in this case include four horizontally-oriented shelving units 561 (shelving unit 561-1, shelving unit 561-2, shelving unit 561-3, and shelving unit 561-4) that are spaced equidistantly relative to each adjacent shelving unit 561. Each shelving unit 561 has a number of boxes 562 stacked thereon. There is also a forklift 563 positioned in the aisle formed between shelving unit 561-1 and shelving unit 561-2.

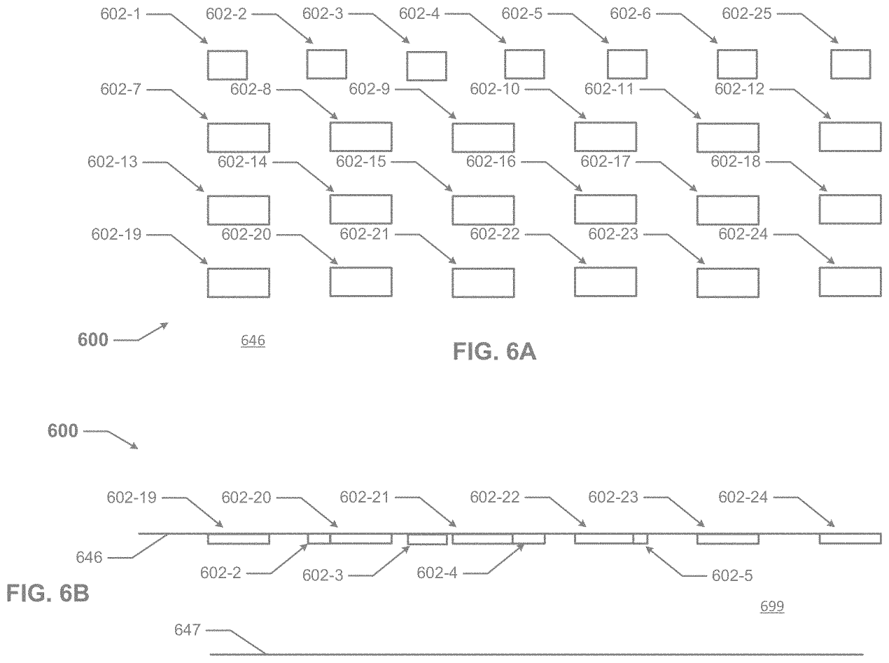

FIGS. 6A and 6B show an example system 600 in accordance with certain example embodiments. Specifically, FIG. 6A shows a bottom view of the system 600, and FIG. 6B shows a side view of the system 600. Referring to FIGS. 1 through 6B, the system 600 of FIGS. 6A and 6B includes a number of electrical devices 602, which in this case are all light fixtures 602. All of the light fixtures 602 in the system 600 of FIGS. 6A and 6B are arranged in a type of grid pattern in the same plane. Specifically, in this case, all of the light fixtures 602 are disposed on a ceiling 646, which along with a floor 647, help define a volume of space 699. Further, while not expressly shown in FIGS. 6A and 6B, each light fixture 602 in the system 600 has its own camera (e.g., camera 175).

The grid pattern formed by the light fixtures 602 is 4 rows, where 3 of the rows have six light fixtures 602, while one of the rows has seven light fixtures 602. One row includes light fixture 602-1, light fixture 602-2, light fixture 602-3, light fixture 602-4, light fixture 602-5, light fixture 602-6, and light fixture 602-25. The next row includes light fixture 602-7, light fixture 602-8, light fixture 602-9, light fixture 602-10, light fixture 602-6, and light fixture 602-12. The next row includes light fixture 602-13, light fixture 602-14, light fixture 602-15, light fixture 602-16, light fixture 602-17, and light fixture 602-18. The final row includes light fixture 602-19, light fixture 602-20, light fixture 602-21, light fixture 602-22, light fixture 602-23, and light fixture 602-24. Each row is substantially equally spaced relative to each other, and for the 3 rows with 6 light fixtures 602 in them, each column is equally spaced relative to each other.

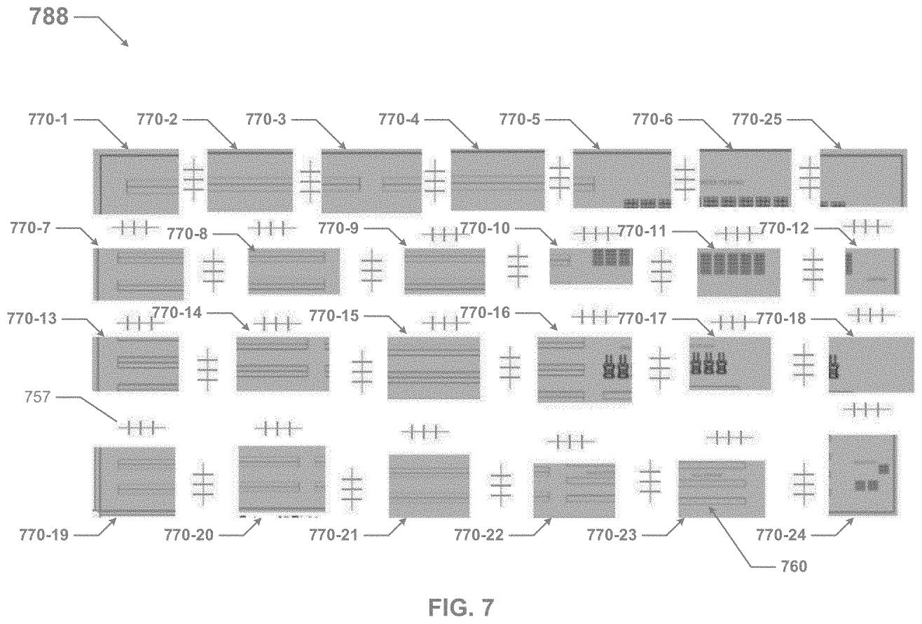

FIG. 7 shows a collection 788 of discrete images 770 captured by the system 600 of FIGS. 6A and 6B. Referring to FIGS. 1 through 7, the collection 788 shows all of the discrete images 770 taken by the cameras of the light fixtures 602 of the system 600 of FIGS. 6A and 6B. Specifically, the camera of light fixture 602-1 of FIGS. 6A and 6B captures image 770-1 shown in FIG. 7. Similarly, the camera of light fixture 602-2 captures image 770-2; the camera of light fixture 602-3 captures image 770-3; the camera of light fixture 602-4 captures image 770-4; the camera of light fixture 602-5 captures image 770-5; the camera of light fixture 602-6 captures image 770-6; the camera of light fixture 602-7 captures image 770-7; the camera of light fixture 602-8 captures image 770-8; the camera of light fixture 602-9 captures image 770-9; the camera of light fixture 602-10 captures image 770-10; the camera of light fixture 602-11 captures image 770-11; the camera of light fixture 602-12 captures image 770-12; the camera of light fixture 602-13 captures image 770-13; the camera of light fixture 602-14 captures image 770-14; the camera of light fixture 602-15 captures image 770-15; the camera of light fixture 602-16 captures image 770-16; the camera of light fixture 602-17 captures image 770-17; the camera of light fixture 602-18 captures image 770-18; the camera of light fixture 602-19 captures image 770-19; the camera of light fixture 602-20 captures image 770-20; the camera of light fixture 602-21 captures image 770-21; the camera of light fixture 602-22 captures image 770-22; the camera of light fixture 602-23 captures image 770-23; the camera of light fixture 602-24 captures image 770-24; and the camera of light fixture 602-25 captures image 770-25.

Each image 770 of the collection 788 in FIG. 7 has at least one object 760. For example, image 770-1 shows objects 760 that include two walls and a shelving unit holding boxes. As another example, image 770-5 shows objects 760 that include a wall, the same shelving unit and boxes as in image 770-1, and some pallets of items. As yet another example, image 770-17 shows objects 760 that include part of a shelving unit holding boxes and three fork lifts.

The camera for each light fixture 602 can have different settings and/or be of a different type than one or more of the other camera used to capture the images 770. As a result, the size and shape of the images 770 in the collection 788 can vary. As stated above, a local controller (e.g., controller 104) to a light fixture 602 and/or the network manager (e.g., network manager 180) can adjust one or more settings of a camera to change the shape and/or size of an image captured by that camera.

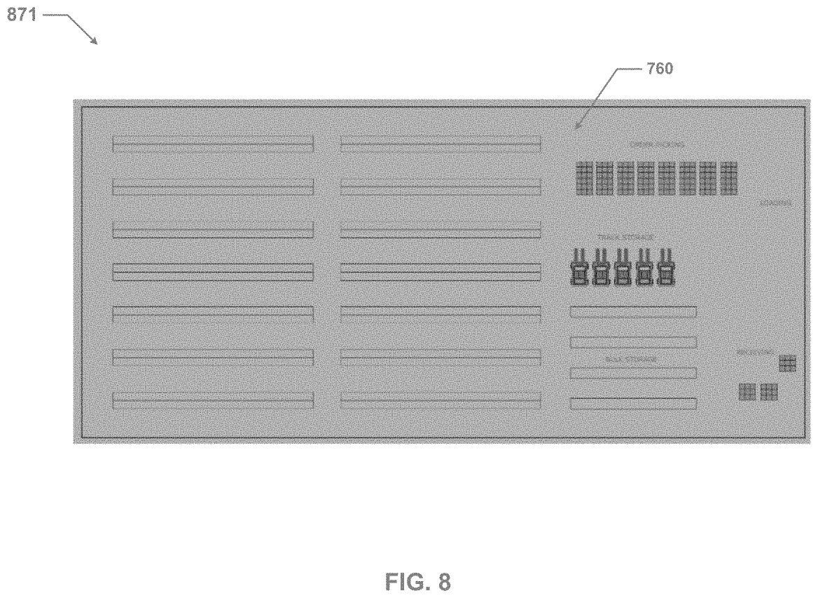

Also, as stated above, the image 770 captured by one light fixture 602 can overlap, or not overlap, with the image 770 captured by an adjacent light fixture 602. In any case, example embodiments can apply virtual stitches 757 to combine all of the images 770 in the collection 788 into a single resulting image, as shown in FIG. 8 below.

FIG. 8 shows a resulting image 871 using the images 770 of FIG. 7 in accordance with certain example embodiments. Referring to FIGS. 1 through 8, the resulting image 871 of FIG. 8 is a composite of all the images 770 of FIG. 7 stitched together into a single image 871. As discussed above, the resulting image 871 can be generated by one or more local controllers (e.g., controller 104), the network manager (e.g., network manager 180), some other controller, or any combination thereof. All of the objects 760 captured in the images 770 of FIG. 7 also appear in the resulting image 871 of FIG. 8, but in the resulting image 871 each object 760 is seamlessly integrated as if the resulting image 871 were a single image captured by a single camera.

The light fixtures 602 of the system 600 of FIGS. 6A and 6B are located in substantially the same plane (in this case, on the ceiling 646), and the resulting image 871 is in two dimensions. In some cases (e.g., if one or more light fixtures 602 or other electrical devices 602 of the system 600 of FIGS. 6A and 6B in the volume of space are not located in the same plane, if one or more of the cameras of an electrical device 602 captures images in 3D), the resulting image 871 can be in three dimensions. In such an example, the resulting image 871 of FIG. 8 could be rotated or otherwise manipulated in three dimensions, and vertical distances (in addition to horizontal distances) can be known and used to perform a function (e.g., commissioning, locating an object 760).

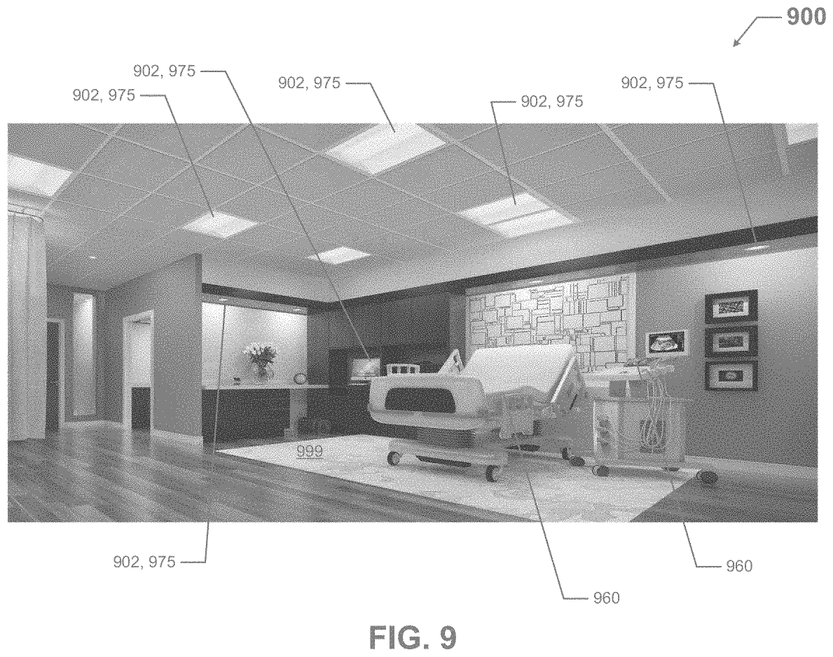

FIG. 9 shows a lighting system 900 that can be used for real-time location of an object 960 and/or for any other purpose described herein in accordance with certain example embodiments. Referring to FIGS. 1 through 9, the lighting system 900 includes a number of electrical devices 902, principally in the form of light fixtures, located in a volume of space 999 that includes a hospital room. A lighting system provides unique advantages for implementing RTLS, commissioning, mapping, and/or other similar functions using example embodiments because the density of the electrical devices 902 (light fixtures) supports a dense network of cameras 975 for capturing images of overlapping portions of the volume of space 999 to eventually arrive at a resulting image of the entire volume of space 999.

Of the electrical devices 902 that are light fixtures, there are seven troffer light fixtures and five down can light fixtures disposed in the ceiling. There is also an electrical device 902 in the form of a computer monitor. In this case, each electrical device 902 includes a camera 975, substantially similar to the cameras 175 discussed above. There are also two identified objects 960 shown in FIG. 9 among a number of potential objects in the volume of space 999. One identified object 960 in FIG. 9 is a test cart, and the other identified object 960 is a bed.

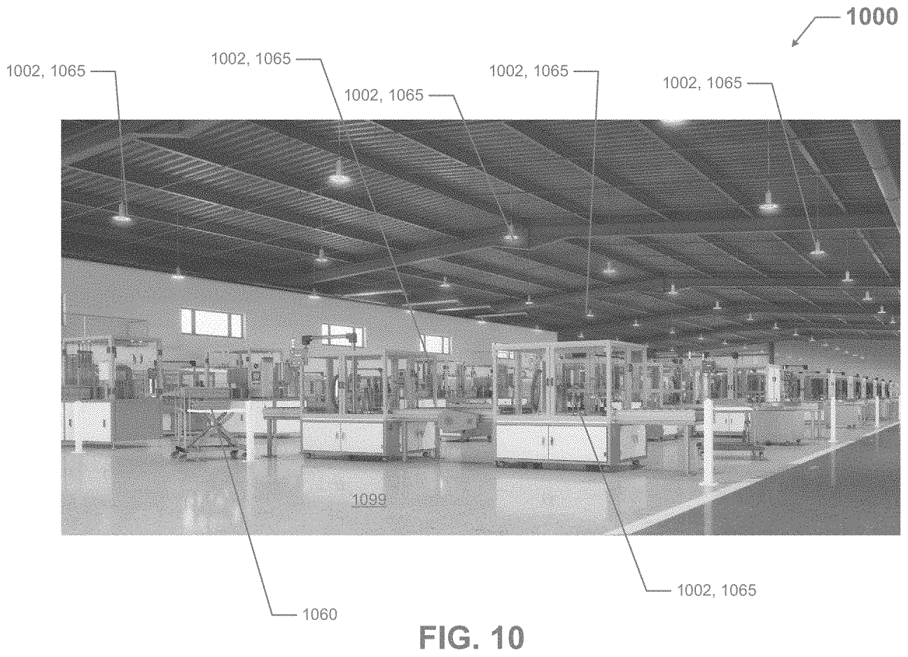

FIG. 10 shows a lighting system 1000 that can be used for real-time location of an object 1060 and/or for any other purpose described herein in accordance with certain example embodiments. Referring to FIGS. 1 through 10, the lighting system 1000 includes a number of electrical devices 1002, principally in the form of light fixtures, located in a volume of space 1099 that includes a manufacturing facility. Of the electrical devices 1002 that are light fixtures, there are at least 56 high bay light fixtures suspended from the ceiling and at least 30 work stations located on the floor. In this case, each electrical device 1002 includes a camera 1075, substantially similar to the cameras 175 discussed above. There is also an object 1060 shown in FIG. 10 that is in the form of a cart.

Example embodiments can stitch together multiple images captured by multiple cameras integrated with multiple electrical devices in a volume of space to generate a single integrated image. The single integrated image generated using example embodiments can be used for one or more of a number of functions, including but not limited to commissioning of one or more electrical devices, mapping the volume of space, and locating/tracking an object in the volume of space. Example embodiments can determine the location of an object in a volume of space independent of ceiling height or other dimensions within the volume of space. Example embodiments can be used in two or three dimensions of space.

Accordingly, many modifications and other embodiments set forth herein will come to mind to one skilled in the art to which example embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A system disposed in a volume of space, the system comprising:
a first camera disposed in the volume of space, wherein the first camera captures a first image of a first portion of the volume of space;
a second camera disposed in the volume of space, wherein the second camera captures a second image of a second portion of the volume of space; and
a controller communicably coupled to the first camera and the second camera, wherein the controller:
receives the first image from the first camera and the second image from the second camera;
generates a resulting image by combining the first image and the second image; and
performs an action using the resulting image.

2. The system of claim 1, wherein the first image and the second image overlap each other, and wherein the controller removes an overlapping portion from the resulting image.

3. The system of claim 1, wherein the action comprises implementing a commissioning process.

4. The system of claim 1, wherein the action comprises mapping objects within the volume of space.

5. The system of claim 1, wherein the action comprises locating an object in the volume of space.

6. The system of claim 5, wherein the action further comprises tracking the object in the volume of space.

7. The system of claim 1, wherein the controller is part of a network manager.

8. The system of claim 1, wherein the controller is part of a first electrical device.

9. The system of claim 8, wherein the first electrical device comprises a light fixture.

10. The system of claim 8, wherein the first camera is integrated with the first electrical device.

11. The system of claim 1, wherein the resulting image is in two dimensions.

12. The system of claim 1, wherein the resulting image is in three dimensions.

13. The system of claim 1, wherein the controller controls at least one setting of the first camera.

14. The system of claim 1, further comprising:
a third camera disposed in the volume of space and communicably coupled to the controller, wherein the third camera captures a third image of a third portion of the volume of space,
wherein the controller further receives the third image, and generates the resulting image further using the third image.

15. The system of claim 1, wherein the first camera further captures a third image of the first portion of the volume of space at a subsequent time relative to the first image, wherein the controller determines whether a difference between the third image and the first image affects the action performed based on the resulting image.

16. The system of claim 1, wherein the controller further:
identifies an unclear aspect of the first image;
changes at least one control aspect of the first camera;
directs the first camera to capture a third image after changes to the at least one control aspect; and
receives the third image from the first camera, wherein the third image is used to clarify the unclear aspect of the first image.

17. An electrical device disposed in a volume of space, the electrical device comprising:
a first camera configured to capture a first image of a first portion of the volume of space; and
a controller coupled to the first camera, wherein the controller is configured to:
control the first camera to capture the first image;
receive the first image from the first camera;
receive at least one second image from at least one second camera, wherein the at least one second image is of at least one second portion of the volume of space;
generate a resulting image using the first image and the at least one second image; and
perform an action using the resulting image.

18. The electrical device of claim 17, further comprising:
at least one electrical device component used in operation of the electrical device, wherein information gathered by the controller from the first image is independent of the operation of the electrical device.

19. A controller comprising:
a memory that stores a plurality of instructions;
a hardware processor; and
a control engine executing the plurality of instructions on the hardware processor, wherein the control engine is configured to:
receive a plurality of images from a plurality of cameras;
generate a resulting image using at the plurality of images; and
perform an action using the resulting image.

20. The controller of claim 19, wherein the control engine is further configured to control operation and settings of the plurality of cameras.
